(19) United States
(12) Patent Application Publication
(10) Pub. No.: US 2015/0074786 A1
(43) Pub. Date: Mar. 12, 2015

(54) METHOD OF AUTOMATICALLY AUTHENTICATING A USER AND ELECTRONIC DEVICE THEREFOR

(71) Applicant: Samsung Electronics Co., Ltd., Suwon-si (KR)

(72) Inventors: Joo-Sic HWANG, Gumi-si (KR); Ki-Wan KWON, Gumi-si (KR); Min-Chul KIM, Daegu (KR); Ki-Bong KIM, Daegu (KR); Seung-Hwan CHO, Yongin-si (KR); Seon-Sook LEE, Gumi-si (KR)

(21) Appl. No.: 14/477,251

(22) Filed: Sep. 4, 2014

(30) Foreign Application Priority Data
Sep. 9, 2013 (KR) 10-2013-0108156

(51) Int. Cl. H04L 29/06

(52) U.S. Cl. CPC H04L 63/0861; H04L 63/083
USPC 726/9

(57) ABSTRACT

A method of operating by an electronic device is provided. The method includes displaying a user interface that requests an input of login information on a display, wherein the display is comprised in the electronic device, displaying that a login using biometric information is possible, instead of the login using the login information, on the display, receiving the biometric information associated with the login information, and performing the login in response to reception of the biometric information.

### CROSS-REFERENCE TO RELATED APPLICATION(S)

This application claims the benefit under 35 U.S.C. §119(a) of a Korean patent application filed on Sep. 9, 2013 in the Korean Intellectual Property Office and assigned Serial number 10-2013-0108156, the entire disclosure of which is hereby incorporated by reference.

### TECHNICAL FIELD

The present disclosure relates to a method of automatically authenticating a user and an electronic device therefore.

### BACKGROUND

These days, internet services needing user authentication are increasing, and a main method of user authentication is one in which a user desiring to use the internet services inputs an Identification (ID) and a password. Websites providing the internet services may have a user input an ID and a password and may store the ID and the password. When the ID and the password are set in this way, the user logs in to the corresponding website using the ID and the password and is provided with the internet services.

The websites providing the internet services also support a method of automatically saving the user's ID and password. When using such an auto-saving method as described above, the user can be provided with the internet services from a corresponding website even without logging in to the website.

The above information is presented as background information only to assist with an understanding of the present disclosure. No determination has been made, and no assertion is made, as to whether any of the above might be applicable as prior art with regard to the present disclosure.

### SUMMARY

However, the auto-saving method has a problem in that the user cannot easily recognize his/her own login state in the mobile environment. Furthermore, since the login is automatically performed, people other than the user can login with the user's account through the auto-saving method, thus resulting in security problems.

Aspects of the present disclosure are to address at least the above-mentioned problems and/or disadvantages and to provide at least the advantages described below. Accordingly, an aspect of the present disclosure is to provide a method of easily automatically authenticating a user in a website while achieving security enhancement and an electronic device therefore.

In accordance with an aspect of the present disclosure, a method for operating by an electronic device is provided. The method includes displaying a user interface that requests an input of login information on a display, wherein the display is comprised in the electronic device, displaying that a login using biometric information is possible instead of the login using the login information, on the display, receiving the biometric information associated with the login information, and performing the login in response to reception of the biometric information.

In accordance with another aspect of the present disclosure, a method for automatically logging in to a website is provided. The method includes determining whether login information including a user's fingerprint has been stored in advance in response to the website which is connected to through a browser, and informing that auto-login is possible when the login information has been stored in advance.

In accordance with another aspect of the present disclosure, an electronic device for automatically logging in to a website is provided. The electronic device includes a screen configured to display a website connected to through a browser, and a controller configured to determine whether login information comprising a user's fingerprint has been stored in advance in response to the website, and control the screen to inform that auto-login is possible when the login information has been stored in advance.

In accordance with another aspect of the present disclosure, a computer-readable recording medium is provided in which a program is recorded for executing a method of automatically logging in to a website. The method includes determining whether login information including a user's fingerprint has been stored in advance in response to the website connected to through a browser, and informing that auto-login is possible when the login information has been stored in advance.

As described above, the present disclosure provides a method of easily automatically authenticating a user in a website while achieving security enhancement and an electronic device therefore.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a flowchart illustrating an example of a method of automatically authenticating a user by an electronic device according to an embodiment of the present disclosure;

FIG. 3 is a flowchart illustrating another example of a method of automatically authenticating a user by an electronic device according to an embodiment of the present disclosure;

FIGS. 4A and 4B illustrate an example in which an electronic device automatically authenticates a user according to an embodiment of the present disclosure;

FIG. 5 illustrates an example in which an electronic device informs that auto-login to a website can be performed according to an embodiment of the present disclosure;

FIG. 6 illustrates another example in which an electronic device informs that auto-login to a website can be performed according to an embodiment of the present disclosure;

FIG. 7 illustrates another example in which an electronic device informs that auto-login to a website can be performed according to an embodiment of the present disclosure;

FIG. 8 illustrates an example in which an electronic device automatically logs in to a website according to an embodiment of the present disclosure;

FIGS. 9A and 9B illustrate another example in which an electronic device automatically logs in to a website according to an embodiment of the present disclosure; and

FIG. 10 illustrates an electronic device receiving a fingerprint for user authentication from other electronic devices according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

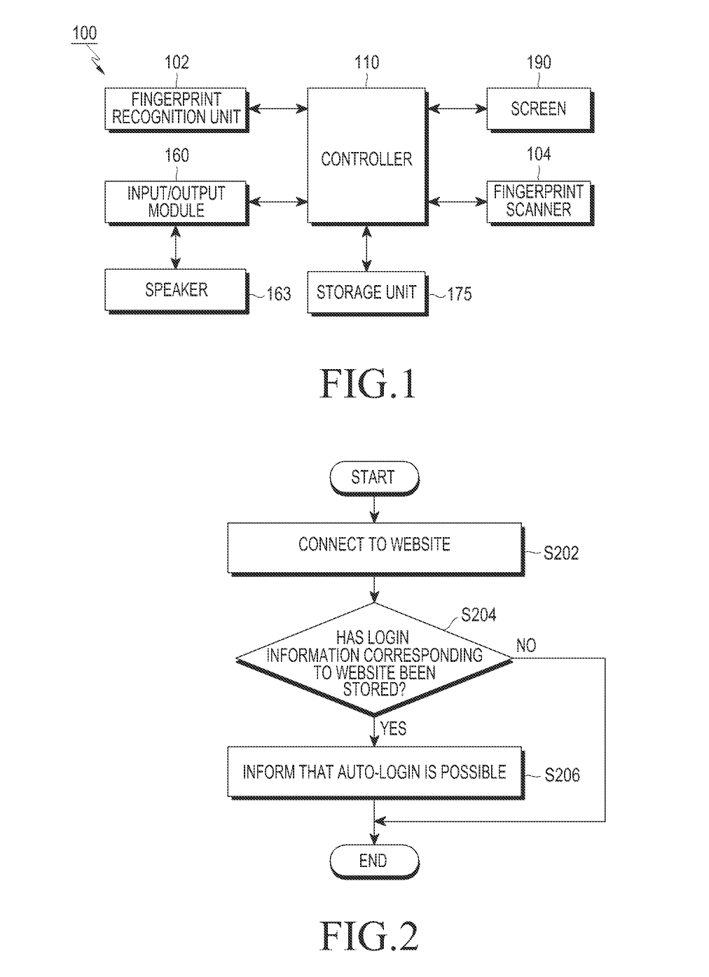

FIG. 1 is a block diagram illustrating a configuration of an electronic device according to an embodiment of the present disclosure.

Referring to FIG. 1, an electronic device 100 may include a fingerprint recognition unit 102, a controller 110, a storage unit 175, and a screen 190, and may further include at least one of a communication interface 120 (not shown), a camera module 150 (not shown), and an input/output module 160.

The fingerprint recognition unit 102 may receive biometric information, such as a fingerprint, from a user that uses the electronic device 100. According to an embodiment of the present disclosure, the fingerprint recognition unit 102 may be implemented in a form of including at least one of a fingerprint scanner 104 and the screen 190.

The fingerprint scanner 104 may scan the fingerprint of the user that uses the electronic device 100. According to an embodiment of the present disclosure, the fingerprint scanner 104 may be separately provided to the electronic device 100 to receive the fingerprint input from the user, however the present disclosure is not limited thereto, and the fingerprint scanner 104 may be included in the electronic device 100. For example, the user may contact a part of his/her finger containing a fingerprint with a separate input unit implemented as the fingerprint scanner 104 to input the fingerprint corresponding to the finger to the electronic device 100. When the part of the finger containing the fingerprint contacts the separate input unit, the fingerprint scanner 104 may scan the part of the finger containing the fingerprint to receive an input of the fingerprint. Hereinafter, for convenience of description, the fingerprint input from the user through the fingerprint recognition unit 102 as described above is referred to as a ‘fingerprint input’.

The controller 110 may control various types of operations of the electronic device 100. Furthermore, the controller 110 may control various types of content being displayed through the screen 190 or the display of the content, by controlling the screen 190. The controller 110 may control the electronic device 100 to perform an operation according to a touch input, namely, a user input sensed through the screen 190. When a touch input to touch at least one point is entered through the screen 190, the controller 110 may control the electronic device 100 to perform an operation corresponding to the touch input.

The controller 110, according to an embodiment of the present disclosure, may be implemented in a form of including a browser that is an application for a connection to a website. According to an embodiment of the present disclosure, the controller 110 may determine whether an authentication procedure may be automatically performed in the website which is currently connected to using the browser. The authentication procedure according to the present embodiment may include, for example, auto-login. The controller 110 according to an embodiment of the present disclosure may determine whether the authentication procedure, for example auto-login, may be performed for the website connected to through the browser. When the determination result shows that the auto-login may be performed, the controller 110 may inform a user that the auto-login may be performed, using the screen 190 or a speaker 163 included in the input/output module 160 and/or in the electronic device 100. According to an embodiment of the present disclosure, when at least one of an ID, a password, and a fingerprint has already been stored in the storage unit 175 as login information corresponding to the website to which the browser connects, the controller 110 may determine that it is possible to automatically log in to the website.

According to an embodiment of the present disclosure, the controller 110 may control the fingerprint recognition unit 102 to receive a fingerprint input from a user for auto-login. The controller 110 may determine whether the fingerprint input is identical to the fingerprint previously stored in the storage unit 175. When the fingerprint is identical to the fingerprint previously stored in the storage unit 175, the controller 110 may determine to automatically log in to the website. In contrast, when the fingerprint input is not identical to the fingerprint previously stored in the storage unit 175, the controller 110 may determine not to automatically log in to the website. According to an embodiment of the present disclosure, when the fingerprint input is not identical to the fingerprint previously stored in the storage unit 175, the controller 110 may control the electronic device 100 to terminate the login operation, namely, the authentication procedure.

According to an embodiment of the present disclosure, when similarity between the fingerprint input entered through the fingerprint recognition unit 102 and the pre-stored fingerprint is larger than a reference value, e.g., a threshold of 80%, previously stored in the storage unit 175, the controller 110 may determine that the fingerprint input is the same as the fingerprint previously stored in the storage unit 175.

According to an embodiment of the present disclosure, the controller 110 may determine whether a connection has been previously made to the website currently connected to through the browser. When the determination result shows that the connection has been previously made to the website, the controller 110 may search the storage unit 175 to identify whether login information corresponding to the website has been stored in the storage unit 175. According to an embodiment of the present disclosure, when the determination result shows that the connection has not been previously made to the website, that is, when the corresponding website is connected to for the first time, the controller 110 may control the electronic device 100 to perform a registration operation for authentication in the corresponding website, for example, an operation of receiving an ID and a password for login from a user.

Furthermore, the controller 110 may control the electronic device 100 to receive a user input from the user to determine whether to store the ID and the password. Moreover, the controller 110 may control the electronic device 100 to receive a user input to determine whether to perform auto-login to the corresponding website using the ID and the password. When determining to perform the auto-login to the website, the controller 110 may receive an input of a fingerprint from the user by controlling the fingerprint recognition unit 102 and may match the fingerprint with the website or the user to store it in the storage unit 175. According to another embodiment of the present disclosure, the controller 110 may control the communication interface 120 to transmit the fingerprint input through the fingerprint recognition unit 102 to a fingerprint server (not illustrated). According to an embodiment of the present disclosure, the fingerprint server may receive the fingerprint from the electronic device 100 and match the fingerprint with the user to store it in the fingerprint server.

The communication interface 120 performs wired and/or wireless communication of the electronic device 100 via a communication connection. According to an embodiment of the present disclosure, the communication interface 120 may allow the electronic device 100 to be connected with an external device using at least one antenna (not illustrated) under the control of the controller 110. At this time, the electronic device 100 and the external device may be connected through mobile communication. The communication interface 120 may transmit/receive wireless signals for a voice call, a video call, a Short Message Service (SMS) or a Multimedia Message Service (MMS) to/from a mobile phone (not illustrated) with phone numbers input to the electronic device 100, a smart phone (not illustrated), a tablet Personal Computer (PC) (not illustrated), or other devices (not illustrated).

The communication interface 120, according to an embodiment of the present disclosure, may connect to a user-desired website and receive various pieces of data from the corresponding website. Furthermore, the communication interface 120 may transmit an ID and/or a password for login to the website.

According to an embodiment of the present disclosure, the communication interface 120 may transmit the fingerprint input from the user to an external device, e.g., the fingerprint server, etc., under the control of the controller 110. Furthermore, the communication interface 120 may transmit the fingerprint input from the user through the fingerprint scanner 104 to other electronic devices or an external server, e.g., the fingerprint server. According to an embodiment of the present disclosure, the communication interface 120 may also receive a user's fingerprint from other electronic devices connected with the electronic device 100 in a wired and/or wireless manner.

The fingerprint server, according to an embodiment of the present disclosure, may match the fingerprint received from the electronic device 100 with the user and store it therein. Furthermore, the fingerprint server may transmit a user's fingerprint to the electronic device 100 in response to a request of the electronic device 100. According to another embodiment of the present disclosure, the fingerprint server may also receive a fingerprint input from the electronic device 100. The fingerprint server may also compare the fingerprint input with the corresponding user's fingerprint and transmit the comparison result to the electronic device 100. That is, based on the comparison result received from the fingerprint server, the controller 110 of the electronic device 100, according to an embodiment of the present disclosure, may also determine whether the fingerprint input is identical to the user's fingerprint.

According to an embodiment of the present disclosure, the controller 110 may determine auto-login to a website using a face image or an iris image captured by the camera module 150. At this time, a user's face image or iris image may have been previously stored in the storage unit 175, and when the user's face image or iris image input through the camera module 150 in real time are identical to the face image or the iris image previously stored in the storage unit 175, the controller 110 may control the electronic device 100 to perform the auto-login to the website.

As described above, the controller 110, according to an embodiment of the present disclosure,may receive biometric information, such as the fingerprint image, the iris image, the face image, or the like, from the user. Furthermore, the controller 110 may control a display, namely, the screen 190, to inform that the login to the website may be performed using the biometric recognition information.

According to an embodiment of the present disclosure, when a browser connects to a website, the controller 110 may control the screen 190 to display a user interface for requesting an input of login information for a user. According to an embodiment of the present disclosure, the controller 110 may control the screen 190 to display a login page for logging in to a website using a browser. According to an embodiment of the present disclosure, the controller 110 may control the electronic device 100 to receive biometric information, e.g., a fingerprint, an iris image, a face image, etc., associated with the login information. When receiving the biometric information from the user, the controller 110 may control the electronic device 100 to perform a login operation.

According to an embodiment of the present disclosure, when an external object, for example, a stylus pen or a user's finger, touches or closely approaches a part of the user interface, the controller 110 may control the screen 190 to display that auto-login may be performed by using the biometric information. At this time, the part of the user interface may include an area configured to receive login information on the screen 190.

According to an embodiment of the present disclosure, the controller 110 may control the electronic device 100 to receive the biometric information on at least one portion of the area configured to receive the login information. According to an embodiment of the present disclosure, the controller 110 may control the communication interface 120 to request and receive the biometric information from another electronic device connected with the electronic device 100 in a wired and/or wireless manner.

The camera module 150 may receive an image input through a previously equipped lens (not illustrated) and convert it into a still image or a moving image. According to an embodiment of the present disclosure, the camera module 150 may include a first camera (not illustrated) disposed on a front surface of the electronic device 100 and a second camera (not illustrated) disposed on a rear surface of the electronic device 100. The first or second camera may include an auxiliary light source, e.g., a flash (not illustrated), for providing light needed for photography. According to another embodiment of the present disclosure, the first and second cameras may be arranged adjacent to each other, e.g., an interval between the first camera and the second camera is larger than 1 cm or smaller than 8 cm, to photograph a 3D still image or a 3D moving image.

The first camera of the camera module 150, according to an embodiment of the present disclosure, may capture the iris of a user, who uses the electronic device 100, under the control of the controller 110.

The input/output module 160 may receive a user input from a user. The input/output module 160, according to an embodiment of the present disclosure, may receive the user input to execute a browser for a connection to a website. Furthermore, the input/output module 160 may receive an ID and a password from the user to log in to the website.

A speaker 163 (not shown) may output, to the outside of the electronic device 100, sounds corresponding to various signals, e.g., a wireless signal, a broadcast signal, a digital audio file, a digital video file, photographing a picture, and the like, generated by the electronic device 100 under the control of the controller 110. According to an embodiment of the present disclosure, the speaker 163 may output sounds corresponding to functions performed by the electronic device 100, e.g., a button control sound or a ring back tone corresponding to a telephone call. One or more speakers 163 may be formed on an appropriate position or positions of a housing of the electronic device 100. When auto-login to a website connected to through a web-browser may be performed, the speaker 163, according to an embodiment of the present disclosure, may output a voice signal informing that the auto-login is possible. At this time, the voice signal informing that the auto-login is possible may have been previously stored in the storage unit 175.

According to an embodiment of the present disclosure, the electronic device 100 may include a proximity sensor (not illustrated). The proximity sensor may sense a user's motion, e.g., a movement of a user's finger), within a predetermined range close to the screen 190 or to the fingerprint recognition unit 120. For example, when the screen 190 is implemented as a capacitive type, the proximity sensor may detect the user's motion by sensing a change in electrostatic capacity generated within a predetermined range from the screen 190, e.g., within a height of 10 cm from the screen 190. The user's motion sensed in this way may also be included in a user input,such as a hovering input. The proximity sensor, according to an embodiment of the present disclosure, may sense a user input, namely, a hovering input, for entering an ID or a password.

Various types of data for control of the electronic device 100 are stored in the storage unit 175. IDs and passwords corresponding to websites may be stored in the storage unit 175 according to an embodiment of the present disclosure. At this time, the IDs and the passwords may be stored in the storage unit 175 in a format encrypted by the controller 110. Furthermore, a fingerprint of a user using the electronic device 100 may be stored in the storage unit 175.

The screen 190 may display various pieces of data stored for control of the electronic device 100. According to an embodiment of the present disclosure, the screen 190 may be implemented in a form of being included in the display of the electronic device 100. Furthermore, the screen 190 may be implemented in a touch screen form to receive a user input, e.g. a touch input, generated by contacting a user's body part, e.g., a finger, with the screen 190. Furthermore, the screen 190 may provide a user with a user interface corresponding to various services, for example, a phone call, data transmission, broadcasting, and photographing a picture. The screen 190 may transmit, to the controller 110, an analog signal, e.g., a touch input, corresponding to at least one touch input to the user interface. The screen 190 may receive an input of at least one touch through a user's body part, e.g., fingers including a thumb, or a touchable input device and/or element, e.g., a stylus pen. Furthermore, the screen 190 may receive a continuous movement of one of the at least one touch. The screen 190 may transmit, to the controller 110, an analog signal corresponding to the continuous movement of the touch input thereto.

In the present disclosure, the touch is not limited to contact between the touch screen 190 and the user's body or the touchable input means, and may include non-contact. That is, the screen 190 may also detect a user input, such as a hovering input, not directly contacting the screen 190 as a touch. According to an embodiment of the present disclosure, a gap between the screen 190 and the input unit in the non-contact type may vary depending on a capability or structure of the electronic device 100. For example, the gap between the screen 190 and the user's body or touchable input means may be less than 3 cm, and according to another embodiment of the present disclosure, may also be more than 3 cm.

The screen 190, according to an embodiment of the present disclosure,may display an execution screen on which a browser for a connection to a website is executed. Furthermore, the screen 190 may display a user interface that requests an input of login information on a user for login to a website. According to an embodiment of the present disclosure, the screen 190 may inform the user that auto-login to the website may be performed under the control of the controller 110. The screen 190, according to an embodiment of the present disclosure, may display a popup window, or may display a notification window on a part of the execution screen.

FIG. 2 is a flowchart illustrating an example of a method of automatically authenticating a user by an electronic device according to an embodiment of the present disclosure.

Referring to FIG. 2, the electronic device 100 connects to a website in operation S202. According to an embodiment of the present disclosure, in operation S202, the user may execute a browser previously stored in an application form in the electronic device 100 to connect to the website. When the browser is executed, the controller 110 may control the communication interface 120 to connect to the website requested by the user. Furthermore, the controller 110 may control the screen 190 to display the website.

The controller 110 determines whether login information corresponding to the website has been previously stored in the storage unit 175 in operation S204. At this time, the login information may include a fingerprint of the user that uses the electronic device 100.

When the determination result in operation S204 shows that the login information corresponding to the website has been stored in the storage unit in operation S204, the electronic device 100 informs the user that it is possible to automatically log in to the website in operation S206. The controller 110 may display through the screen 190 a popup window for displaying that the login may be performed, or may output through a speaker 163 a voice signal for informing that the login may be performed.

When the determination result in operation S204 shows that the login information corresponding to the website has not been stored in the storage unit in operation S204, the controller 110 may control the electronic device 100 to perform no operation and may end the method illustrated in FIG. 2. According to another embodiment of the present disclosure, the controller 110 may request a fingerprint input from the user, and when receiving the fingerprint input from the user, may store the fingerprint input in the storage unit 175 as a fingerprint corresponding to the website.

Furthermore, according to an embodiment of the present disclosure, prior to operation S204, the user may also enter a user input into the electronic device 100 to log in to the website. For example, when the user moves a cursor to an input field to enter an ID or a password, the controller 110 may determine that a user input has been entered for login.

According to another embodiment of the present disclosure, when the determination result in operation S204 shows that the login information corresponding to the website has been stored in the storage unit, the controller 110 may also control the electronic device 100 to inform the user that the auto-login to the website may be performed. According to another embodiment of the present disclosure, the electronic device 100 may store the ID and the password in the storage unit 175 as the login information corresponding to the website. The controller 110 may control the electronic device 100 to log in to the website using the ID and the password stored in the storage unit 175 in correspondence to the website.

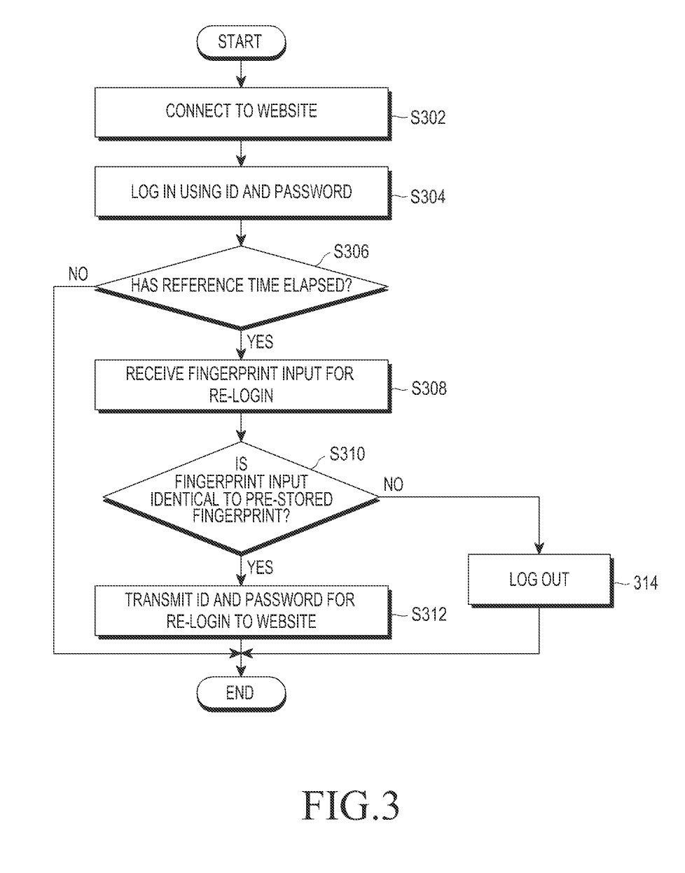

FIG. 3 is a flowchart illustrating another example of a method of automatically authenticating a user by an electronic device according to an embodiment of the present disclosure. In an embodiment of the present disclosure, it is assumed that an ID and a password for login to a website have been previously stored in the storage unit 175 of the electronic device 100.

Referring to FIG. 3, the electronic device 100 connects to the website in operation S302. According to an embodiment of the present disclosure, in operation S302, the user may execute a browser previously stored in the electronic device 100 in an application form to connect to the website. When the browser is executed, the controller 110 may control the communication interface 120 to connect to the website requested by the user. Furthermore, the controller 110 may control the screen 190 to display the website.

When the electronic device 100 connects to the website, the controller 110 logs in to the website using the ID and the password in operation S304. According to an embodiment of the present disclosure, the controller 110 may receive an ID or a password for login to the website from the user through the input/output module 160 or the screen 190. The controller 110 may control the electronic device 100 to log in to the website, by controlling the communication interface 120 to transmit the ID and the password to the website.

Thereafter, the controller 110 may determine whether a reference time, which may be previously stored in the storage unit 175, has elapsed in operation S306. At this time, the reference time may be a time interval when the login is maintained using the ID and the password transmitted to the website in operation S304. According to an embodiment of the present disclosure, the controller 110 may also periodically check and/or determine whether the reference time has elapsed.

When the determination result in operation S306 shows that the reference time has not elapsed, the controller 110 may perform no operation. Furthermore, according to an embodiment of the present disclosure, the controller 110 may also control the electronic device 100 to maintain the current login state.

When the determination result in operation S306 shows that the reference time has elapsed, the electronic device 100 receives a fingerprint input for re-login from the user through the fingerprint recognition unit 102 in operation S308. According to an embodiment of the present disclosure, prior to operation S308, the controller 110 may request the user to enter the fingerprint input.

When the fingerprint input is entered by the user, the controller 110 determines whether the fingerprint input is identical to and/or similar to the fingerprint previously stored in the storage unit 175 in operation S310. In an embodiment of the present disclosure, the controller 110 may authenticate the user that uses the electronic device 100, by determining whether the fingerprint input entered in operation S308 is identical to and/or similar to the fingerprint previously stored in the storage unit 175.

When the determination result in operation S310 shows that the fingerprint input is identical to and/or similar to the previously stored fingerprint, the communication interface 120 transmits the ID and the password for re-login to the website under the control of the controller 110 in operation S312. Accordingly, the electronic device 100 may maintain the login to the website.

When the determination result in operation S310 shows that the fingerprint input is not identical to and/or similar to the previously stored fingerprint, the electronic device 100 may log out in operation S314. When the fingerprint input is not identical toad/or similar to the fingerprint stored in the storage unit 175, the controller 110 may determine that the user having logged in to the website in operation S304 differs from the user having entered the fingerprint input. Accordingly, the controller 110 may control the electronic device 100 to log out from the website.

In an embodiment of the present disclosure, through the operation S306, the determination has been made as to whether the reference time has elapsed. However, according to another embodiment of the present disclosure, instead of the operation in operation S306, the communication interface 120 of the electronic device 100 may also receive a request for the ID and the password for re-login from the website. When the website requests the ID and the password, the controller 110 may also determine that the re-login is needed.

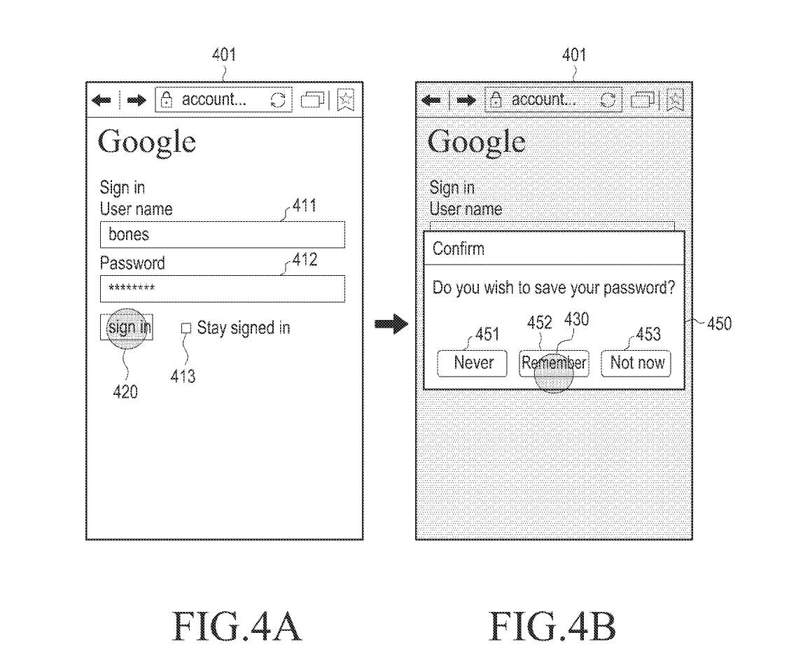

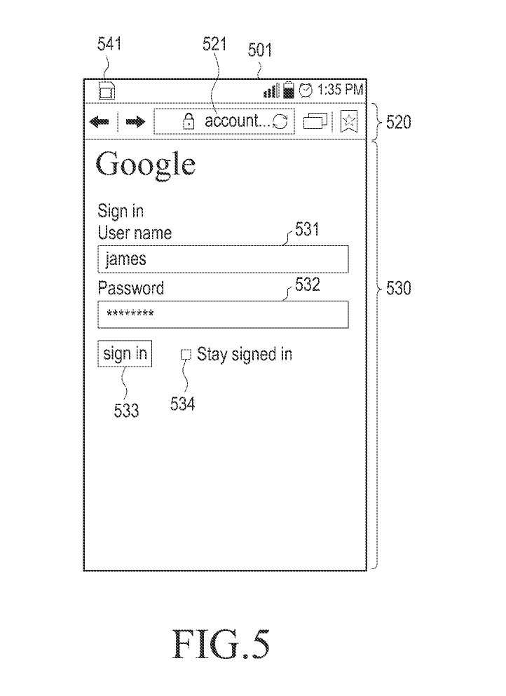

FIGS. 4A and 4B illustrate an example in which an electronic device automatically authenticates a user according to an embodiment of the present disclosure.

FIG. 4A shows an execution screen 401 of a browser for inputting an ID and a password to a website, and FIG. 4B shows a popup window 450 for determining whether to store the ID and the password in correspondence to the website.

Referring to FIG. 4A, the electronic device 100 may display the website and receive the ID and the password from the user to log in to the website. The electronic device 100 may respectively input the ID and the password in an ID input field 411 and a password input field 412, according to a user input. Furthermore, the electronic device 100 may configure auto-login to the website by selecting a “Stay signed in” checkbox 413 according to a user input. The electronic device 100 may log in to the website according to a user input 420 for requesting the login to the website. According to an embodiment of the present disclosure, the electronic device 100 may also transmit the ID and the password to the website only when the user input 420 to select a login button is entered.

When the user requests the login to the website, as illustrated in FIG. 4A, the controller 110, as illustrated in FIG. 4B, may control the screen 190 to display the popup window 450 for determining whether to store the ID or the password in correspondence to the website. The user may enter a user input 430 into the electronic device 100 to select one of three input buttons 451, 452, and 453, which may respectively correspond to different storage options with respect to storing the ID or the password, contained in the popup window 450. Referring to FIG. 4B, the user input 430, selecting one of the three input buttons 451, 452, and 453, to make a request for storing the ID and the password in correspondence to the website is entered into the electronic device 100.

According to the user input 430 described above, the controller 110 may store the ID and the password in the storage unit 175 in correspondence to the website. Furthermore, after the ID and the password are stored in the storage unit as described above, every time the electronic device 100 connects to the website, the controller 110 may control the screen 190 to load the ID and the password from the storage unit 175 and display the ID and the password in the ID input field 411 and the password input field 412, respectively, even without a separate input. Furthermore, according to an embodiment of the present disclosure, whenever the electronic device 100 connects to the website, the controller 110 may also control the electronic device 100 to transmit the ID and the password to the website even without a separate input.

FIG. 5 illustrates an example in which an electronic device informs that auto-login to a website can be performed according to an embodiment of the present disclosure. Referring to FIG. 5, it is assumed that it is possible to automatically log in to the website to which the electronic device 100 connects.

FIG. 5 shows an execution screen 501 of a browser displayed on the screen 190, wherein the browser receives a request for an ID and a password from the website. Referring to FIG. 5, the electronic device 100 displays the website through the screen 190 and receives an ID and a password from a user to log in to the website. Referring to FIG. 5, the electronic device 100 may input the ID and the password in an ID input field 531 and a password input field 532, respectively, according to a user input. Furthermore, the electronic device 100 may configure auto-login to the website by selecting a “Stay signed in” checkbox 534 according to a user input. The electronic device 100 may log in to the website according to a user input to select a button 533 for login and/or signing in to the website.

In an embodiment of the present disclosure, the execution screen 501 of the browser may be divided into a menu area 520 for displaying an address of the website to which the browser connects, and a content area 530 for providing various content items provided from the website to which the browser connects. It is assumed that the ID and the password for login to the website are input through the content area 530.

The electronic device 100 according to an embodiment of the present disclosure may display a fingerprint icon 541 and an address field 521 of the menu area 520 under the control of the controller 110 in order to inform the user that the auto-login to the website may be performed. According to another embodiment of the present disclosure, the fingerprint icon 541 may be displayed at any one portion on the execution screen 501, for example, on an upper or lower side of the execution screen 501. Furthermore, while the login operation is being performed, the fingerprint icon 541 may also be displayed in the overlay form on the execution screen 501.

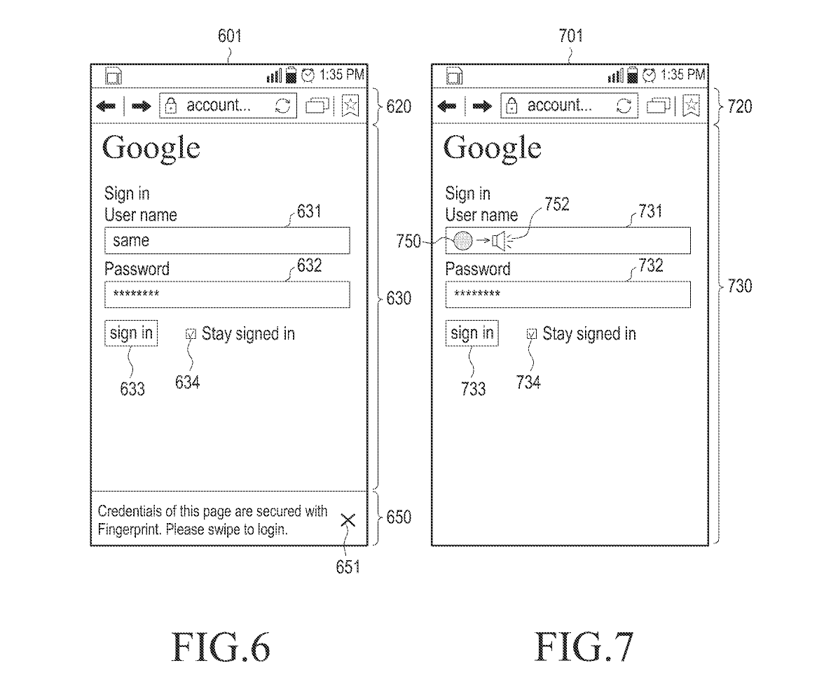

FIG. 6 illustrates another example in which an electronic device informs that auto-login to a website will be performed according to an embodiment of the present disclosure. Likewise to FIG. 5, referring to FIG. 6, it is assumed that it is possible to automatically log in to the website to which the electronic device 100 connects.

FIG. 6 shows an execution screen 601 of a browser displayed on the screen 190, wherein the browser receives a request for an ID and a password from the website. Referring to FIG. 6, the electronic device 100 displays the website through the screen 190 and receives an ID and a password from a user to log in to the website. In an embodiment of the present disclosure, the execution screen 601 of the browser may be divided into a menu area 620 for displaying an address of the website to which the browser connects and a content area 630 for providing various content items provided from the website to which the browser connects. It is assumed that the ID and the password for login to the website are input through the content area 630.

Referring to FIG. 6, the electronic device 100 may input the ID and the password in an ID input field 631 and a password input field 632, respectively, according to a user input. Furthermore, the electronic device 100 may configure auto-login to the website by selecting a “Stay signed in” checkbox 634 according to a user input. The electronic device 100 may log in to the website according to a user input to select a button 633 for login and/or signing in to the website.

In an embodiment of the present disclosure, the execution screen 601 of the browser may include a notification area 650 for notifying that the auto-login to the website may be performed. The electronic device 100 may display the notification area 650 on a lower side of the execution screen 601 to inform the user that it is possible to automatically log in to the website to which the browser connects at present. Furthermore, according to an embodiment of the present disclosure, a controller 110 may control the screen 190 to display, within the notification area 650, a clear button 651 for removing the notification area 650. When the user enters a user input to select the clear button 651, the controller 110 may remove, i.e., clear, the notification area 650 from the execution screen 601. In an embodiment of the present disclosure, the notification area 650 is located on the lower side of the execution screen 601, and yet according to another embodiment of the present disclosure, the notification area 650 may also be displayed between the menu area 620 and the content area 630, or on an upper, left, or right side of the execution screen 601.

FIG. 7 illustrates another example in which an electronic device informs that auto-login to a website will be performed according to an embodiment of the present disclosure. Referring to FIG. 7, it is assumed that it is possible to re-log in to the website to which the electronic device 100 connects.

FIG. 7 shows an execution screen 701 of a browser displayed on the screen 190, and the browser receives a request for an ID and a password from the website. In an embodiment of the present disclosure, the execution screen 701 of the browser may be divided into a menu area 720 for displaying an address of the website to which the browser connects and a content area 730 for providing various content items provided from the website to which the browser connects. In an embodiment of the present disclosure, the ID and the password for login to the website may be input through the content area 730.

Referring to FIG. 7, the electronic device 100 displays the website through the screen 190 and receives an ID and a password from a user to log in to the website. Referring to FIG. 7, the electronic device 100 may input the ID and the password in an ID input field 731 and a password input field 732, respectively, according to a user input. Furthermore, the electronic device 100 may configure auto-login to the website by selecting a “Stay signed in” checkbox 734 according to a user input. The electronic device 100 may log in to the website according to a user input to select a button 733 for login and/or signing in to the website.

In an embodiment of the present disclosure, when the user selects the ID input field 731, the electronic device 100 may output, through the speaker 163, a guide sound 752 representing that the auto-login to the website may be performed. For example, when a cursor 750 is located in the ID input field 731, a controller 110 may determine that the ID input field 731 has been selected and control the speaker 163 to output the guide sound 752. According to another embodiment of the present disclosure, when a stylus pen or the user's finger is located above the ID input field 731, the controller 110 may also determine that the ID input field has been selected. The user input through the stylus pen or the user's finger may be a hovering input. The electronic device 100, according to an embodiment of the present disclosure, may sense the user input through the stylus pen or the user's finger using a proximity sensor, even though the user input does not contact the screen 190.

In an embodiment of the present disclosure, the electronic device 100 outputs the guide sound 752 through the speaker 163 when the ID input field 731 is selected. However, according to another embodiment of the present disclosure, the controller 110 may control the electronic device 100 such that the speaker 163 outputs the guide sound 752 even when at least one of the password input field 732, the login button 733, and the “Stay signed in” checkbox 734 is selected.

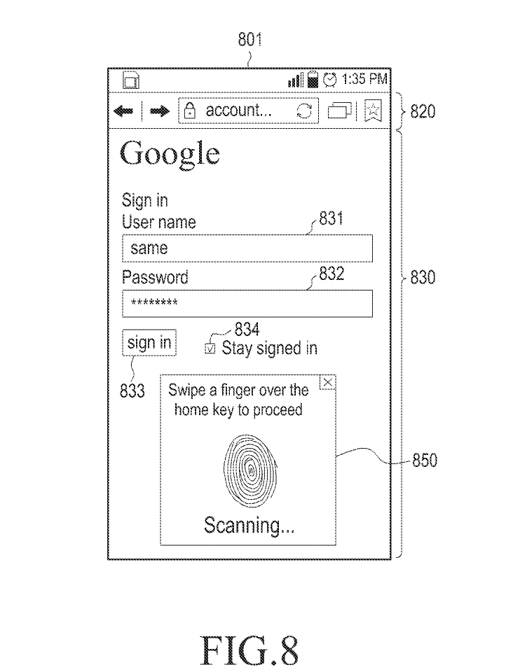

FIG. 8 illustrates an example in which an electronic device automatically logs in to a website according to an embodiment of the present disclosure. Referring to FIG. 8, it is assumed that it is possible to automatically log in to the website to which the electronic device 100 connects.

FIG. 8 shows an execution screen 801 of a browser displayed on the screen 190, and the browser receives a request for an ID and a password from the website. In an embodiment of the present disclosure, the execution screen 801 of the browser may be divided into a menu area 820 for displaying an address of the website to which the browser connects and a content area 830 for providing various content items provided from the website to which the browser connects. In an embodiment of the present disclosure, the ID and the password for login to the website may be input through the content area 830.

Referring to FIG. 8, the electronic device 100 displays the website through the screen 190 and receives an ID and a password from a user to log in to the website. Referring to FIG. 8, the electronic device 100 may input the ID and the password in an ID input field 831 and a password input field 832, respectively, according to a user input. Furthermore, the electronic device 100 may configure auto-login to the website by selecting a “Stay signed in” checkbox 834 according to a user input. The electronic device 100 may log in to the website according to a user input to select a button 833 for login or signing in to the website.

According to an embodiment of the present disclosure, the screen 190 of the electronic device 100 may be implemented in the form of including the fingerprint scanner 104 to receive a fingerprint input from the user. Furthermore, a controller 110 may control the screen 190 to display, on the execution screen 801, a fingerprint input window 850 for receiving the fingerprint input from the user. Accordingly, the user may put his/her finger on the fingerprint input window 850 to enter the fingerprint input into the electronic device 100. When the user enters the fingerprint input, the controller 110 may determine whether the fingerprint input, namely, the fingerprint scanned by the fingerprint scanner 104 is identical to a fingerprint previously stored in the storage unit 175. When the fingerprint input is identical to the fingerprint previously stored in the storage unit 175, the controller 110 may control the communication interface 120 to transmit the ID and the password to the website for login to the website.

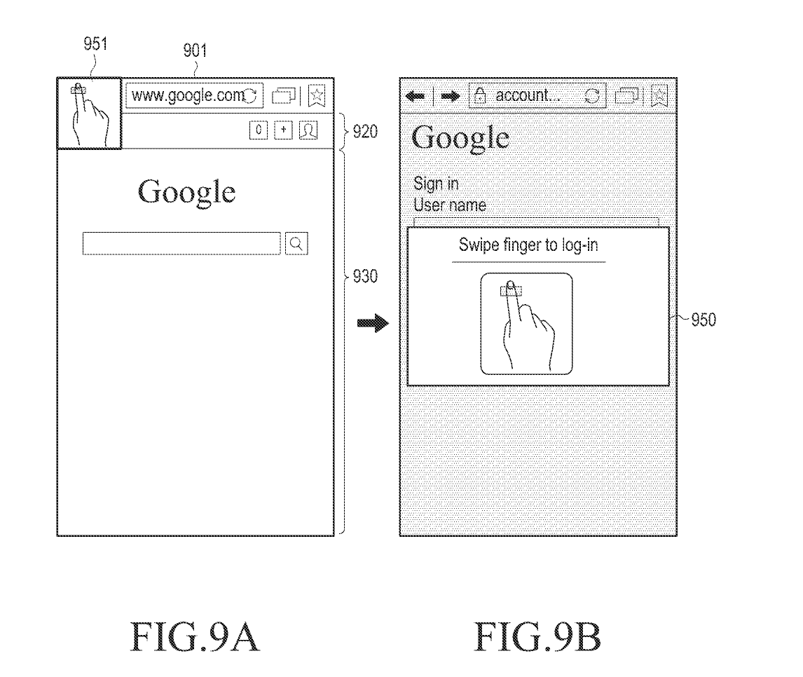

FIGS. 9A and 9B illustrate another example in which an electronic device automatically logs in to a website according to an embodiment of the present disclosure.

FIG. 9A shows an execution screen 901 informing that a fingerprint input is needed for login to the website, and FIG. 9B shows a fingerprint input window on the execution screen 901. Referring to FIGS. 9A and 9B, it is assumed that it is possible to automatically log in to the website to which the electronic device 100 connects. Furthermore, the execution screen 901 may be divided into a menu area 920 for displaying an address of the website to which a browser connects and a content area 930 for providing various content items provided from the website to which the browser connects.

Referring to FIG. 9A, the electronic device 100 displays a fingerprint input icon 951 on an upper left side of the execution screen 901 to inform a user that a fingerprint input is required for re-login. When the user enters a user input to select the fingerprint input icon 951, a controller 110 may control the screen 190 to display the fingerprint input window 950, as illustrated in FIG. 9B.

For example, when a stylus pen or the user's finger is located on the fingerprint input icon 951, the controller 110 may determine that the fingerprint input icon 951 is selected. Furthermore, the user may put his/her finger on the fingerprint input window 950 to enter a fingerprint input into the electronic device 100. When the user enters the fingerprint input, the controller 110 may determine whether the fingerprint input, namely, the fingerprint scanned by a fingerprint scanner 104 is identical to a fingerprint previously stored in the storage unit 175. When the fingerprint input is identical to the fingerprint previously stored in the storage unit, the controller 110 may control a communication interface 120 to transmit an ID and a password to the website for login to the website.

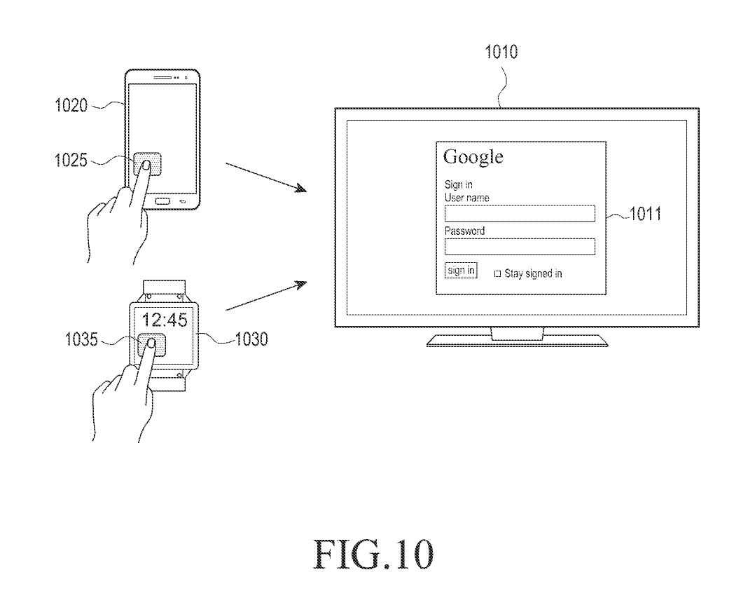

FIG. 10 illustrates an electronic device receiving a fingerprint from other electronic devices according to an embodiment of the present disclosure.

Referring to FIG. 10, a first electronic device 1010 connects to a website using a browser, and the browser displays an execution screen 1011 for login to the website. In an embodiment of the present disclosure, it is assumed that the first electronic device 1010 is wirelessly connected with a second electronic device 1020 and/or a third electronic device 1030. The first electronic device 1010 may receive a fingerprint input for auto-login to the website from the second electronic device 1020 or the third electronic device 1030. In an embodiment of the present disclosure, the second and third electronic devices 1020 and 1030 are assumed to include fingerprint scanners 1025 and 1035, respectively, for receiving a fingerprint input from a user. When it is needed to log in or re-log in to the website connected to with the first electronic device 1010, the first electronic device 1010 may receive the fingerprint input that is entered into the fingerprint scanner 1025 or 1035 from a respective one of the second electronic device 1020or the third electronic device 1030. When the fingerprint input received from the second electronic device 1020or the third electronic device 1030 is identical and/or similar to the user's previously stored fingerprint, the first electronic device 1010 may transmit an ID and a password to the website.

According to an embodiment of the present disclosure, when the login or re-login to the website is needed, the first electronic device 1010 may request the second electronic device 1020or the third electronic device 1030 to transmit a fingerprint input entered by the user.

It can be seen that the method of automatically authenticating the user according to various embodiments of the present disclosure can be implemented in the form of hardware, software, or a combination of hardware and software. Such an arbitrary software may be stored in, for example, irrespective of being erasable or rewritable, a volatile or non-volatile storage device such as a Read-Only Memory (ROM), a memory such as a Random Access Memory (RAM), a memory chip device, a processor, or an integrated circuit, an optically or magnetically recordable and a machine readable, e.g., a computer readable, storage medium such as a Compact Disc (CD), a Digital Versatile Disc (DVD), a magnetic disk, or a magnetic tape. It can be also appreciated that the memory included in the mobile terminal is one example of machine-readable devices suitable for storing a program including instructions that are executed by a processor device to thereby implement various embodiments of the present disclosure. Accordingly, the present disclosure may include a program including a code for implementing a device and a method described in an arbitrary claim of the present specification, and a machine readable, e.g., a computer readable, storage medium storing such a program. Furthermore, such a program may be electronically transferred through an arbitrary medium such as a communication signal transferred through a wired or wireless connection, and the present disclosure may appropriately include equivalents thereof.

In addition, the electronic device may receive the program from a program providing device connected thereto in a wired or wireless manner and store the received program. The program providing device may include a program including instructions allowing the electronic device to perform the method of modifying the text input by the user, a memory that stores information required for the method of modifying the text input by the user, a communication unit that performs wired or wireless communication with the electronic device, and a controller that transmits the corresponding program to the electronic device in response to a request of the electronic device or automatically.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating by an electronic device, the method comprising:
displaying a user interface that requests an input of login information on a display, wherein the display is comprised in the electronic device;
displaying that a login using biometric information is possible, instead of the login using the login information, on the display;
receiving the biometric information associated with the login information; and
performing the login in response to reception of the biometric information.

2. The method of claim 1, wherein displaying the user interface comprises:
displaying a login page of a website by using a browser.

3. The method of claim 1, wherein displaying that the login using the biometric information is possible comprises:
displaying that the login using the biometric information is possible on the display in response to at least one of a touch and a close approach of an external object to at least part of the user interface.

4. The method of claim 3, wherein the at least part of the user interface comprises an area,on the display, that is configured to receive the login information.

5. The method of claim 4, wherein receiving the biometric information comprises:
receiving the biometric information through the at least part of the user interface that comprises the area configured to receive the login information.

6. The method of claim 1, wherein receiving the biometric information associated with the login information comprises:
receiving the biometric information from another electronic device connected with the electronic device using at least one of a wired communication connection or a wireless communication connection.

7. The method of claim 1, wherein displaying that the login using biometric information is possible comprises:
displaying, on the display, an icon indicating that the login using the biometric information is possible.

8. A method for automatically logging in to a website at an electronic device, the method comprising:
determining whether login information comprising a user's fingerprint has been stored in advance in response to the website which is connected to through a browser; and
informing that auto-login is possible when the login information has been stored in advance.

9. The method of claim 8, before determining whether the login information comprising the user's fingerprint has been stored in advance, further comprising:
connecting to the website through the browser; and
logging in to the website by transmitting an ID and a password corresponding to the website.

10. The method of claim 9, after informing that the auto-login is possible, further comprising:
determining whether a reference time, the reference time being pre-stored, has elapsed; and
requesting a fingerprint input from the user when the reference time has elapsed.

11. The method of claim 10, further comprising:
receiving the fingerprint input from the user; and
logging in to the website by transmitting, to the website, the ID and the password corresponding to the website when the fingerprint input is identical to the user's fingerprint.

12. The method of claim 8, wherein informing that the auto-login is possible comprises:
displaying a popup window for informing that the auto-login is possible on an execution screen displayed through a screen comprised in the electronic device.

13. The method of claim 8, wherein informing that the auto-login is possible comprises:
displaying that the auto-login is possible on at least part of an execution screen displayed through a screen.

14. The method of claim 8, wherein informing that the auto-login is possible comprises:
outputting voice for informing that the auto-login is possible when a user input is sensed for selecting at least one of an input field for an input of an ID and an input field for an input of a password on an execution screen displayed through a screen comprised in the electronic device.

15. The method of claim 11, wherein receiving the fingerprint input from the user comprises:
scanning the user's fingerprint by using a fingerprint scanner on a screen.

16. The method of claim 8, wherein the user's fingerprint that has been stored in advance is stored in at least one of a storage unit of the electronic device and a fingerprint server connected to the electronic device.

17. An electronic device for automatically logging in to a website, the electronic device comprising:
a screen configured to display a website connected to through a browser; and
a controller configured to:
determine whether login information comprising a user's fingerprint has been stored in advance in response to the website, and
control the screen to inform that auto-login is possible when the login information has been stored in advance.

18. The electronic device of claim 17, further comprising:
a communication interface configured to connect to the website through the browser,
wherein the controller is configured to control the communication interface to log in to the website by transmitting an ID and a password corresponding to the website.

19. The electronic device of claim 18, wherein the controller is configured to determine whether a reference time, the reference time being pre-stored, has elapsed, and
wherein the controller is configured to control the screen to request a fingerprint input from the user when the reference time has elapsed.

20. The electronic device of claim 19, wherein the controller is configured to determine if the fingerprint input received from the user is identical to a user's fingerprint that is stored in at least one of a storage unit of the electronic device and a fingerprint server.

21. The electronic device of claim 19, wherein the screen is configured to receive the fingerprint input from the user, and
wherein the controller is configured to control the communication interface to log in to the website by transmitting, to the website, the ID and the password corresponding to the website when the fingerprint input is identical to user's fingerprint.

22. The electronic device of claim 17, wherein the screen is configured to display a popup window for informing that the auto-login is possible on at least part of an execution screen displayed through the screen.

23. The electronic device of claim 17, wherein the screen displays that the auto-login is possible on at least part of an execution screen displayed through the screen.

24. The electronic device of claim 17, further comprising:
a speaker configured to output voice for informing that the auto-login is possible when a user input is sensed for selecting at least one of an input field for an input of an ID and an input field for an input of a password on an execution screen displayed through the screen.

25. The electronic device of claim 21, wherein the screen scans the user's fingerprint by using a fingerprint scanner on the screen.

26. A non-transitory computer-readable recording medium in which a program is recorded for executing a method of automatically logging in to a website, wherein the method comprises:
determining whether login information comprising a user's fingerprint has been stored in advance in response to the website connected to through a browser; and
informing that auto-login is possible when the login information has been stored in advance.
